(19) United States
(12) Patent Application Publication
(10) Pub. No.: US 2010/0176121 A1
(43) Pub. Date: Jul. 15, 2010

(54) MICROWAVE PROCESSING APPARATUS

(75) Inventors: Tomotaka Nobue, Nara (JP); Makoto Mihara, Nara (JP); Kenji Yasui, Nara (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/376,604

(22) PCT Filed: Aug. 7, 2007
(86) PCT No.: PCT/JP2007/065456

§ 371 Date: Feb. 6, 2009

(30) Foreign Application Priority Data
Aug. 8, 2006 (JP) 2006-215697
Jul. 27, 2007 (JP) 2007-196537

(51) Int. Cl. H05B 6/68; H05B 6/72

(52) U.S. Cl. 219/716; 219/761

(57) ABSTRACT

A microwave oven includes a microwave generation device and a case. Three antennas are provided in the case. The two antennas are opposite each other along a horizontal direction. In the microwave generation device, a power distributor almost equally distributes a microwave generated by a microwave generator among phase variators. Each of the phase variators adjusts the phase of the fed microwave. This causes a phase difference between microwaves respectively radiated from the opposite two antennas to change. The microwaves are respectively radiated from the antennas.

### TECHNICAL FIELD

The present invention relates to a microwave processing apparatus that processes an object using a microwave.

### BACKGROUND ART

Examples of apparatuses that process objects using microwaves include microwave ovens. In the microwave ovens, microwaves generated from microwave generators are radiated to heating chambers made of metals. This causes objects arranged inside the heating chambers to be heated using the microwaves.

Conventionally, magnetrons have been used as the microwave generation devices in the microwave ovens. In this case, the microwaves generated by the magnetrons are fed into the heating chambers through waveguides.

Here, when the electromagnetic wave distributions of the microwaves inside the heating chambers are non-uniform, the objects cannot be uniformly heated. Therefore, a microwave oven that feeds a microwave generated by a magnetron into a heating chamber through first and second waveguides has been proposed (see Patent Document 1).

[Patent Document 1] JP 2004-47322 A

### DISCLOSURE OF THE INVENTION

### Problems to be Solved by the Invention

The waveguides for feeding the microwaves generated by the magnetrons into the heating chambers are formed of hollow metal tubes. Consequently, in the microwave oven disclosed in Patent Document 1, a plurality of metal tubes for forming the first and second waveguides are required. This causes the microwave oven to increase in size.

Furthermore, Patent Document 1 discloses that the microwave generated by the magnetron is radiated from a plurality of radiation antennas rotatably provided. In this case, the microwave oven also increases in size in order to get a rotational space of each of the radiation antennas.

An object of the present invention is to provide a microwave processing apparatus that gives a microwave to an object in a desired electromagnetic wave distribution and is sufficiently miniaturized.

### Means for Solving the Problems

(1) According to an aspect of the present invention, a microwave processing apparatus that processes an object using a microwave includes a microwave generator that generates a microwave, and at least first and second radiators that radiate to the object the microwave generated by the microwave generator, in which a phase difference between microwaves respectively radiated from the first and second radiators changes.

In the microwave processing apparatus, the microwave generated by the microwave generator is radiated to the object from the first and second radiators. This causes the microwave radiated from the first radiator and the microwave radiated from the second radiator to interface with each other in the vicinity of the object.

Here, when the phase difference between the microwaves respectively radiated from the first and second radiators is changed, a state where the microwaves respectively radiated from the first and second radiators interfere with each other changes. This causes an electromagnetic wave distribution around the object to change. Consequently, it is possible to feed the microwaves to the object in a desired electromagnetic wave distribution. As a result, the object can be uniformly processed, or a desired portion of the object can be concentrically processed.

In this case, the necessity of a mechanism and a space for moving the object as well as the first and second radiators is eliminated, which causes the microwave processing apparatus to be sufficiently miniaturized and made low in cost.

(2) According to another aspect of the present invention, a microwave processing apparatus that processes an object using a microwave includes a microwave generator that generates a microwave, first and second radiators that respectively radiate to the object the microwave generated by the microwave generator, and a first phase variator that changes a phase difference between microwaves respectively radiated from the first and second radiators, in which the first and second radiators are arranged such that the radiated microwaves interfere with each other.

In the microwave processing apparatus, the microwave generated by the microwave generator is radiated to the object from the first and second radiators.

The first and second radiators are arranged such that the microwaves respectively radiated therefrom interfere with each other. This causes the microwave radiated from the first radiator and the microwave radiated from the second radiator to interface with each other.

The first phase variator changes a phase difference between the microwaves respectively radiated from the first and second radiators. Thus, a state where the microwaves respectively radiated from the first and second radiators interfere with each other changes. This causes an electromagnetic wave distribution around the object to change. Consequently, it is possible to feed the microwaves to the object in a desired electromagnetic wave distribution. As a result, the object can be uniformly processed, or a desired portion of the object can be concentrically processed.

In this case, the necessity of a mechanism and a space for moving the object as well as the first and second radiators is eliminated, which causes the microwave processing apparatus to be sufficiently miniaturized and made low in cost.

(3) The first and second radiators may be opposite each other.

In this case, the object is arranged between the first radiator and the second radiator, which allows the microwaves to be respectively reliably radiated to the object from the first and second radiators. Further, the first and second radiators are opposite each other, so that the microwave radiated from the first radiator and the microwave radiated from the second radiator reliably interfere with each other.

(4) The microwave processing apparatus may further include a detector that detects respective reflected powers from the first and second radiators, and a controller that controls the microwave generator, in which the controller may cause the first and second radiators to radiate the microwaves to the object while changing the frequency of the microwave generated by the microwave generator, determine the frequency of the microwave for processing the object as a processing frequency on the basis of a frequency at which the reflected power detected by the detector take a minimum or minimal value, and causes the microwave generator to generate the microwave having the determined processing frequency.

In this case, the microwaves are respectively radiated to the object from the first and second radiators while changing the frequency of the microwave generated by the microwave generator. At this time, the frequency of the microwave for processing the object is determined as the processing frequency on the basis of the frequency at which summation of the reflected powers from the first and second radiators, which are detected by the detector respectively, take a minimum or minimal value. The microwave having the determined processing frequency is generated by the microwave generator.

Since the microwave having the processing frequency determined on the basis of the frequency at which summation of the reflected powers from the first and second radiators respectively take a minimum or minimal value is used for processing the object, the reflected powers generated when the object is processed are reduced. This causes the power conversion efficiency of the microwave processing apparatus to be improved.

Furthermore, even when the microwave generator generates heat due to the reflected powers, its heat value is reduced. As a result, the microwave generator is prevented from being damaged and failing due to the reflected powers.

(5) The controller may cause the first and second radiators to radiate the microwaves to the object while changing the frequency of the microwave generated by the microwave generator before the object is processed, and determine the frequency of the microwave for processing the object as a processing frequency on the basis of the frequency at which the reflected power detected by the detector take a minimum or minimal value.

In this case, the microwaves are respectively radiated to the object from the first and second radiators while changing the frequency of the microwave generated by the microwave generator before the object is processed. At this time, the frequency of the microwave for processing the object is determined as the processing frequency on the basis of the frequency at which summation of the reflected powers from the first and second radiators, which are detected by the detector respectively, take a minimum or minimal value.

Thus, the microwave generator can generate the microwave having the determined processing frequency when the processing of the object is started. This allows the reflected powers generated when the processing of the object is started to be reduced. As a result, the microwave generator is prevented from being damaged and failing due to the reflected powers.

(6) The controller may cause the first and second radiators to radiate the microwaves to the object while changing the frequency of the microwave generated by the microwave generator while the object is processed, and determine the frequency of the microwave for processing the object as a processing frequency on the basis of the frequency at which the reflected power detected by the detector take a minimum or minimal value.

In this case, the microwaves are respectively radiated to the object from the first and second radiators while changing the frequency of the microwave generated by the microwave generator while the object is processed. At this time, the frequency of the microwave for processing the object is determined as the processing frequency on the basis of the frequency at which the summation of reflected powers from the first and second radiators, which are detected by the detector respectively, take a minimum or minimal value.

Even while the object is processed, therefore, the microwave having the determined processing frequency is used for processing the object every time a predetermined time period has elapsed or when the reflected powers exceed a predetermined threshold value, for example. Thus, the reflected powers that change with time as the processing of the object progresses are inhibited from increasing. This causes the power conversion efficiency of the microwave processing apparatus to be improved.

Furthermore, even when the microwave generator generates heat due to the reflected powers, its heat value is reduced. As a result, the microwave generator is prevented from being damaged and failing due to the reflected powers.

(7) The first radiator may radiate the microwave along a first direction, and the second radiator may radiate the microwave along a second direction opposite to the first direction. The microwave processing apparatus may further include a third radiator that radiates the microwave generated by the microwave generator to the object along a third direction crossing the first direction.

In this case, the microwave is radiated to the object along the first direction from the first radiator, and the microwave is radiated to the object in the second direction opposite to the first direction from the second radiator. Further, the microwave is radiated to the object in the third direction crossing the first direction from the third radiator.

The microwaves can be thus respectively radiated to the object along the different first, second, and third directions. Therefore, the object can be efficiently heated irrespective of the directivity of the microwaves.

(8) The microwave generator may include first and second microwave generators, the first and second radiators may radiate to the object the microwave generated by the first microwave generator, and the third radiator may radiate to the object the microwave generated by the second microwave generator.

In this case, the microwaves generated by the common first microwave generator are respectively radiated to the object from the first and second radiators. Therefore, the phase difference between the microwaves respectively radiated from the first and second radiators can be easily changed by the first phase variator.

Furthermore, the microwave generated from the second microwave generator is radiated to the object from the third radiator. Therefore, the frequency of the microwave radiated from the third radiator can be controlled independently of the frequencies of the microwaves respectively radiated from the first and second radiators. This allows the reflected powers generated when the object is processed to be sufficiently reduced. As a result, the power conversion efficiency of the microwave processing apparatus is sufficiently improved.

(9) The first radiator may radiate the microwave along a first direction, and the second radiator may radiate the microwave along a second direction opposite to the first direction. The microwave processing apparatus may further include a third radiator that radiates the microwave generated by the microwave generator to the object along a third direction crossing the first direction, and a fourth radiator that radiates the microwave generated by the microwave generator to the object along a fourth direction opposite to the third direction, in which the third and fourth radiators may be opposed to each other.

In this case, the microwave is radiated to the object along the first direction from the first radiator, and the microwave is radiated to the object in the second direction opposite to the first direction from the second radiator. Further, the microwave is radiated to the object along the third direction crossing the first direction from the third radiator, and the microwave is radiated to the object along the fourth direction opposite to the third direction from the fourth radiator.

The object can be thus radiated along the different first, second, third, and fourth directions. Therefore, the object can be more efficiently heated irrespective of the directivity of the microwaves.

(10) The microwave processing apparatus may further include a second phase variator that changes a phase difference between the microwaves respectively radiated from the third and fourth radiators.

An electromagnetic wave distribution between the third radiator and the fourth radiator that are opposite each other can be changed by changing the phase difference between the microwaves respectively radiated from the third and fourth radiators. Consequently, it is possible to feed the microwaves to the object in a desired electromagnetic wave distribution. As a result, the object can be uniformly processed, or a desired portion of the object can be concentrically processed.

In this case, the necessity of a mechanism and a space for moving the object as well as the first, second, third, and fourth radiators is eliminated, which causes the microwave processing apparatus to be miniaturized and made lower in cost.

(11) The microwave generator may include first and second microwave generators, the first and second radiators may radiate to the object the microwave generated by the first microwave generator, and the third and fourth radiators may radiate to the object the microwave generated by the second microwave generator.

In this case, the microwaves generated by the common first microwave generator are respectively radiated to the object from the first and second radiators. Therefore, the first phase variator can easily change the phase difference between the microwaves respectively radiated from the first and second radiators.

Furthermore, the microwaves generated by the common second microwave generator are respectively radiated to the object from the third and fourth radiators. Therefore, the second phase variator can easily change the phase difference between the microwaves respectively radiated from the third and fourth radiators.

This allows the frequencies of the microwaves respectively radiated from the first and second radiators and the frequencies of the microwaves respectively radiated from the third and fourth radiators to be independently controlled.

This allows the reflected power generated when the object is processed to be further sufficiently reduced. As a result, the power conversion efficiency of the microwave processing apparatus to be further sufficiently improved.

(12) The object may be processed by heating processing. The microwave processing apparatus may further include a heating chamber that accommodates the object for heating. In this case, the object can be subjected to the heating processing by accommodating the object within the heating chamber.

### EFFECTS OF THE INVENTION

According to the present invention, the electromagnetic wave distribution between the first radiator and the second radiator that are opposite each other can be changed by changing the phase difference between the microwaves respectively radiated from the first and second radiators. Consequently, it is possible to feed the microwaves to the object in a desired electromagnetic wave distribution. As a result, the object can be uniformly processed, or a desired portion of the object can be concentrically processed.

In this case, the necessity of a mechanism and a space for moving the object as well as the first and second radiators is eliminated, which causes the microwave processing apparatus to be miniaturized and made lower in cost.

### BRIEF DESCRIPTION OF THE DRAWINGS

FIG. 1 is a block diagram showing the configuration of a microwave oven according to a first embodiment.

FIG. 2 is a schematic side view of a microwave generation device constituting the microwave oven shown in FIG. 1.

FIG. 3 is a diagram schematically showing the circuit configuration of a part of the microwave generation device shown in FIG. 2.

FIG. 4 is a flow chart showing the procedure for control by a microcomputer shown in FIG. 1.

FIG. 5 is a flow chart showing the procedure for control by a microcomputer shown in FIG. 1.

FIG. 6 is a diagram for explaining mutual interference between microwaves respectively radiated from antennas shown in FIG. 1.

FIG. 7 is a diagram for explaining mutual interference between microwaves in a case where a phase difference between microwaves respectively radiated from antennas shown in FIG. 1 changes.

FIG. 8 is a diagram showing the contents of an experiment for investigating the relationship between a phase difference between microwaves respectively radiated from opposite two antennas and an electromagnetic wave distribution within a case and the results of the experiment.

FIG. 9 is a diagram showing the contents of an experiment for investigating the relationship between a phase difference between microwaves respectively radiated from opposite two antennas and an electromagnetic wave distribution within a case and the results of the experiment.

FIG. 10 is a diagram showing the contents of an experiment for investigating the relationship between a phase difference between microwaves respectively radiated from opposite two antennas and an electromagnetic wave distribution within a case and the results of the experiment.

FIG. 11 is a diagram for explaining a specific example of processing for sweeping and extracting the frequency of a microwave.

FIG. 12 is a block diagram showing the configuration of a microwave oven according to a second embodiment.

FIG. 13 is a block diagram showing the configuration of the microwave oven according to the second embodiment.

FIG. 14 is a block diagram showing the configuration of a microwave oven according to a third embodiment.

FIG. 15 is a block diagram showing the configuration of a microwave oven according to a fourth embodiment.

### BEST MODE FOR CARRYING OUT THE INVENTION

The embodiments of the present invention will be described in detail referring to the drawings. The embodiments below describe a microwave processing apparatus. A microwave oven will be described as an example of the microwave processing apparatus.

### [1] First Embodiment

(1-1) Outline of Configuration and Operations of Microwave Oven

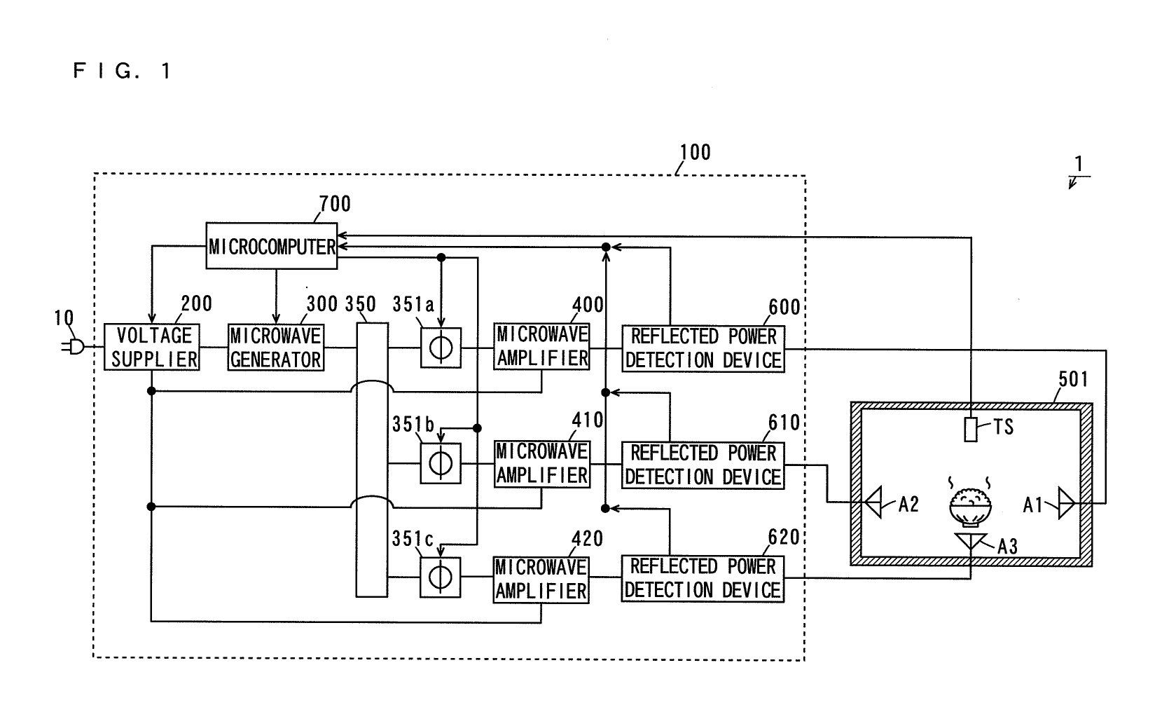

FIG. 1 is a block diagram showing the configuration of a microwave oven according to a first embodiment. As shown in FIG. 1, a microwave oven 1 according to the present embodiment includes a microwave generation device 100 and a case 501. Three antennas A1, A2, and A3 are provided in the case 501.

In the present embodiment, the two antennas A1 and A2 out of the three antennas A1, A2, and A3 within the case 501 are opposite each other in a horizontal direction.

The microwave generation device 100 includes a voltage supplier 200, a microwave generator 300, a power distributor 350, three phase variators 351a, 351b, and 351c having the same configuration, three microwave amplifiers 400, 410, and 420 having the same configuration, three reflected power detection devices 600, 610, and 620 having the same configuration, and a microcomputer 700. The microwave generation device 100 is connected to a commercial power supply through a power supply plug 10.

In the microwave generation device 100, the voltage supplier 200 converts an AC voltage supplied from the commercial power supply into a variable voltage and a DC voltage, and feeds the variable voltage to the microwave generator 300, while feeding the DC voltage to the microwave amplifiers 400, 410, and 420.

The microwave generator 300 generates a microwave on the basis of the variable voltage supplied from the voltage supplier 200. The power distributor 350 almost equally distributes the microwave generated by the microwave generator 300 among the phase variators 351a, 351b, and 351c. The power distributor 350 delays the phase of the microwave inputted to the phase variator 351b by 180 degrees and delays the phase of the microwave inputted to the phase variator 351c by 90 degrees when the phase of the microwave inputted to the phase variator 351a is used as a basis, for example.

Each of the phase variators 351a, 351b, and 351c includes a varactor diode (variable-capacitance diode), for example. Each of the phase variators 351a, 351b, and 351c is controlled by the microcomputer 700, to adjust the phase of the fed microwave.

Note that each of the phase variators 351a, 351b, and 351c may include a pin (PIN) diode and a plurality of lines, for example, in place of the varactor diode.

For example, a phase difference between microwaves respectively radiated from the opposite two antennas A1 and A2 can be changed by controlling at least one of the phase variators 351a and 351b. The details will be described later.

The microwave amplifiers 400, 410, and 420 are operated by the DC voltage supplied from the voltage supplier 200, to respectively amplify microwaves fed from the phase variators 351a, 351b, and 351c. The details of the respective configurations and operations of the voltage supplier 200, the microwave generator 300, and the microwave amplifiers 400, 410, and 420 will be described later.

The reflected power detection devices 600, 610, and 620 respectively include detector diodes, directional couplers, terminators, and so on and feed microwaves amplified by the microwave amplifiers 400, 410, and 420 to the antennas A1, A2, and A3 provided within the case 501. This causes the microwaves to be radiated from the antennas A1, A2, and A3 within the case 501.

At this time, reflective powers are respectively applied to the reflected power detection devices 600, 610, and 620 from the antennas A1, A2, and A3. The reflected power detection devices 600, 610, and 620 respectively feed reflected power detection signals corresponding to the applied reflected powers to the microcomputer 700.

A temperature sensor TS for measuring the temperature of an object is provided within the case 501. A temperature measured value of the object by the temperature sensor TS is given to the microcomputer 700.

The microcomputer 700 controls the voltage supplier 200, the microwave generator 300, and the phase variators 351a, 351b, and 351c. The details will be described later.

(1-2) Details of Configuration of Microwave Generation Device

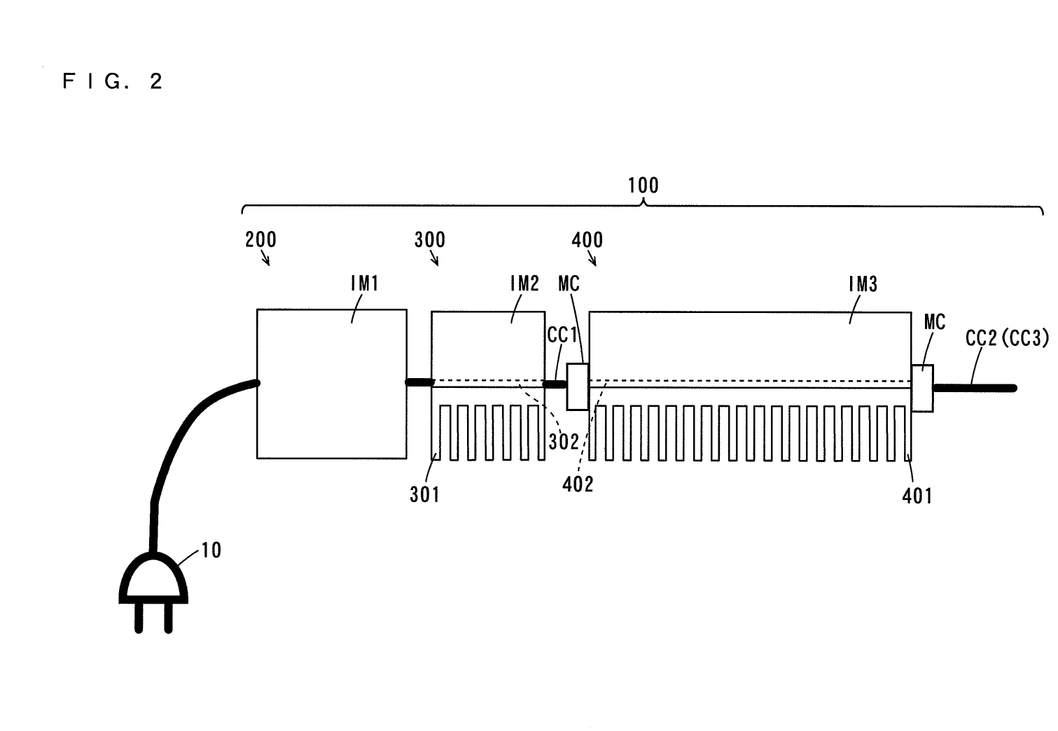

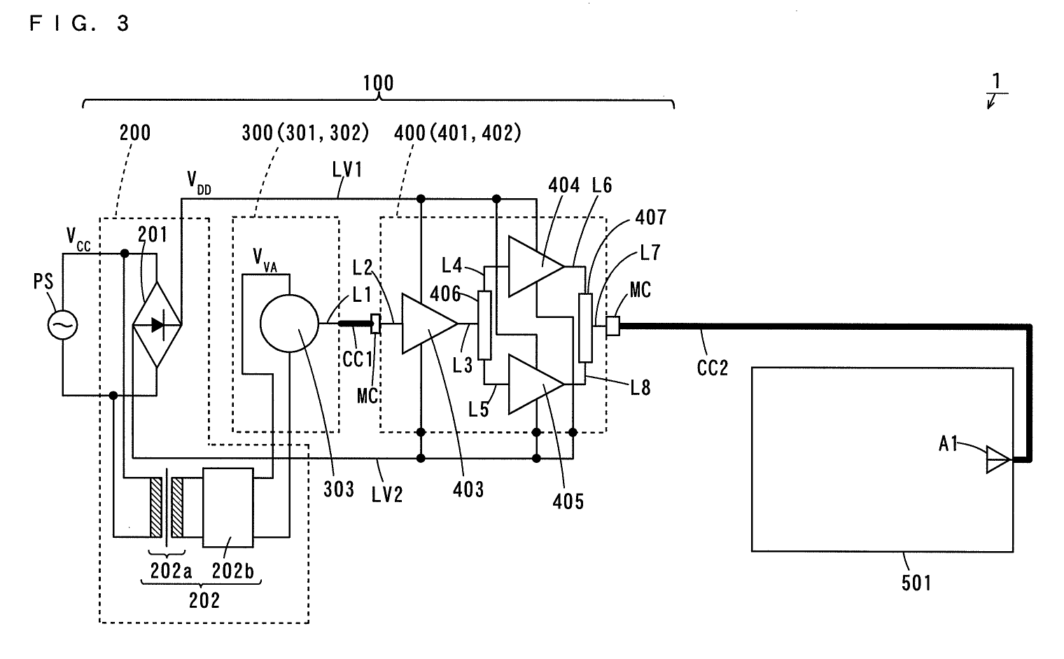

FIG. 2 is a schematic side view of the microwave generation device 100 constituting the microwave oven 1 shown in FIG. 1, and FIG. 3 is a diagram schematically showing the circuit configuration of a part of the microwave generation device 100 shown in FIG. 2.

The details of each of components constituting the microwave generation device 100 will be described on the basis of FIGS. 2 and 3. In FIGS. 2 and 3, the illustration of the power distributor 350, the phase variators 351a, 351b, and 351c, the microwave amplifiers 410 and 420, the reflected power detection devices 600, 610, and 620, and the microcomputer 700 is omitted.

The voltage supplier 200 shown in FIG. 2 includes a rectifier circuit 201 (FIG. 3) and a voltage control device 202 (FIG. 3). The voltage control device 202 includes a transformer 202a and a voltage control circuit 202b. The rectifier circuit 201 and the voltage control device 202 are accommodated in a case IM1 (FIG. 2) composed of an insulating material such as resin.

The microwave generator 300 shown in FIG. 2 includes a radiator fin 301 and a circuit board 302. A microwave generator 303 shown in FIG. 3 is formed in the circuit board 302. The circuit board 302 is provided on the radiator fin 301. The circuit board 302 and the microwave generator 303 are accommodated in a metal case IM2 on the radiator fin 301. The microwave generator 303 is composed of a circuit element such as a transistor, for example.

The microwave generator 303 is connected to the microcomputer 700 shown in FIG. 1. This causes the operation of the microwave generator 303 to be controlled by the microcomputer 700.

The microwave amplifier 400 shown in FIG. 2 includes a radiator fin 401 and a circuit board 402. Three amplifiers 403, 404, and 405 shown in FIG. 3 are formed on the circuit board 402. The circuit board 402 is provided on the radiator fin 401. The circuit board 402 and the amplifiers 403, 404, and 405 are accommodated in a metal case IM3 on the radiator fin 401. Each of the amplifiers 403, 404, and 405 is composed of a high thermal stability and high pressure-resistant semiconductor device such as a transistor using GaN (gallium nitride) and SiC (silicon carbide).

As shown in FIG. 3, an output terminal of the microwave generator 303 is connected to an input terminal of the amplifier 403 through a line L1 formed in the circuit board 302, the power distributor 350 and the phase variator 351a shown in FIG. 1 (which are not illustrated in FIG. 3), a coaxial cable CC1, and a line L2 formed in the circuit board 402. Note that the coaxial cable CC1 and the line L2 are connected to each other in an insulating connector MC.

An output terminal of the amplifier 403 is connected to an input terminal of a power distributor 406 through a line L3 formed in the circuit board 402. The power distributor 406 distributes a microwave inputted from the amplifier 403 through the line L3 into two.

Two output terminals of the power distributor 406 are connected to respective input terminals of the amplifiers 404 and 405 through lines L4 and L5 formed in the circuit board 402.

Respective output terminals of the amplifiers 404 and 405 are connected to an input terminal of a power synthesizer 407 through lines L6 and L8 formed in the circuit board 402. The power synthesizer 407 synthesizes respective microwaves inputted thereto. An output terminal of the power synthesizer 407 is connected to one end of a coaxial cable CC2 through a line L7 formed in the circuit board 402. The reflected power detection device 600 shown in FIG. 1 is inserted through the coaxial cable CC2.

The other end of the coaxial cable CC2 is connected to the antenna A1 provided in the case 501. The coaxial cable CC2 and the line L7 are connected to each other in an insulating connector MC.

An AC voltage V_{cc} is applied from the commercial power supply PS to a pair of input terminals of the rectifier circuit 201 and a primary winding of the transformer 202a. The AC voltage V_{cc} is 100 (V), for example. A power supply line LV1 for a high potential and a power supply line LV2 for a low potential are connected to a pair of output terminals of the rectifier circuit 201.

The rectifier circuit 201 rectifies the AC voltage V_{cc} supplied from the commercial power supply PS, and applies a DC voltage V_{DD} between the power supply lines LV1 and LV2. The DC voltage V_{DD} is 140 (V), for example. Respective power supply terminals of the amplifiers 403, 404, and 405 are connected to the power supply line LV1, and respective ground terminals of the amplifiers 403, 404, and 405 are connected to the power supply line LV2.

A secondary winding of the transformer 202a is connected to a pair of input terminals of the voltage control circuit 202b. The transformer 202a decreases the AC voltage V_{cc}. The voltage control circuit 202b feeds a variable voltage V_{VA} optionally adjustable from the AC voltage decreased by the transformer 202a to the microwave generator 303. The variable voltage V_{VA} is a voltage adjustable between 0 (V) and 10 (V), for example.

The microwave generator 303 generates a microwave on the basis of the variable voltage V_{VA} applied from the voltage control circuit 202b. The microwave generated by the microwave generator 303 is fed to the amplifier 403 through the line L1 (the power distributor 350 and the phase variators 351a to 351c in FIG. 1), the coaxial cable CC1, and the line L2.

The amplifier 403 amplifies the power of the microwave fed from the microwave generator 303. The microwave amplified by the amplifier 403 is fed to the amplifiers 404 and 405 through the line L3, the power distributor 406, and the lines L4 and L5.

The amplifiers 404 and 405 amplify the power of the microwave fed from the amplifier 403. The microwaves amplified by the amplifiers 404 and 405 are respectively inputted to the power synthesizer 407 through the lines L6 and L8, and are synthesized by the power synthesizer 407. A composite microwave is outputted from the power synthesizer 407, and is fed to the antenna A1 through the line L7 and the coaxial cable CC2. The respective microwaves fed to the antenna A1 from the amplifiers 404 and 405 are radiated into the case 501.

(1-3) Procedure for Control by Microcomputer

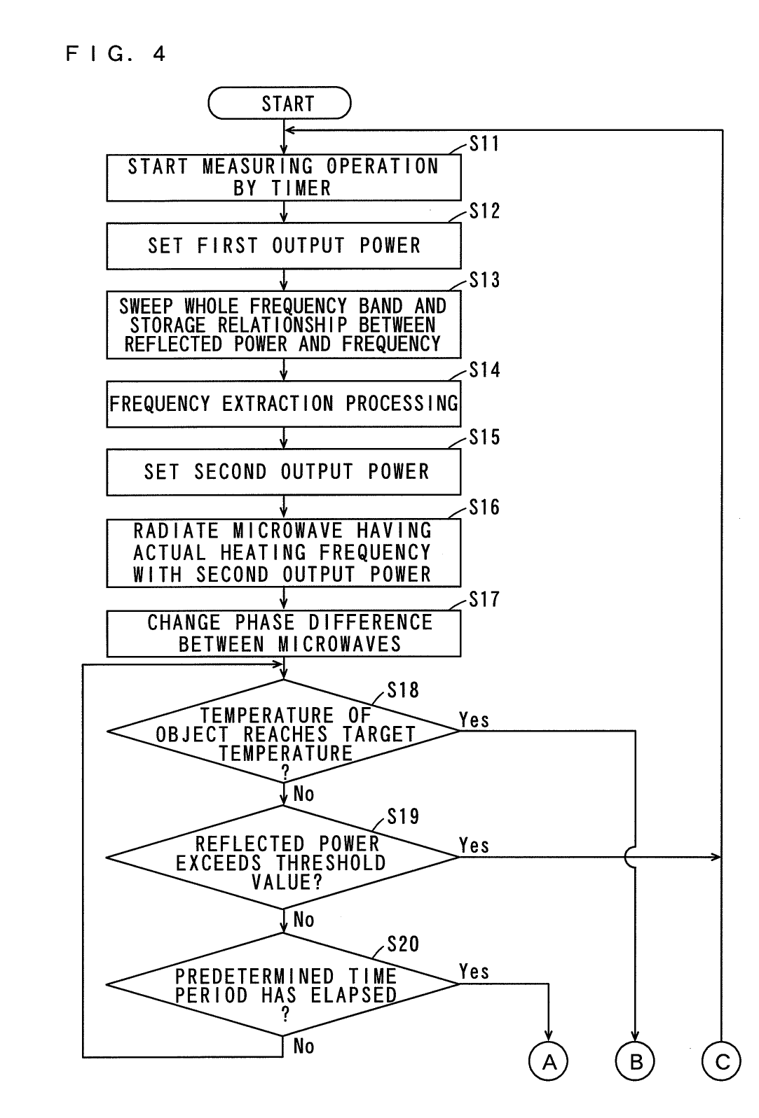

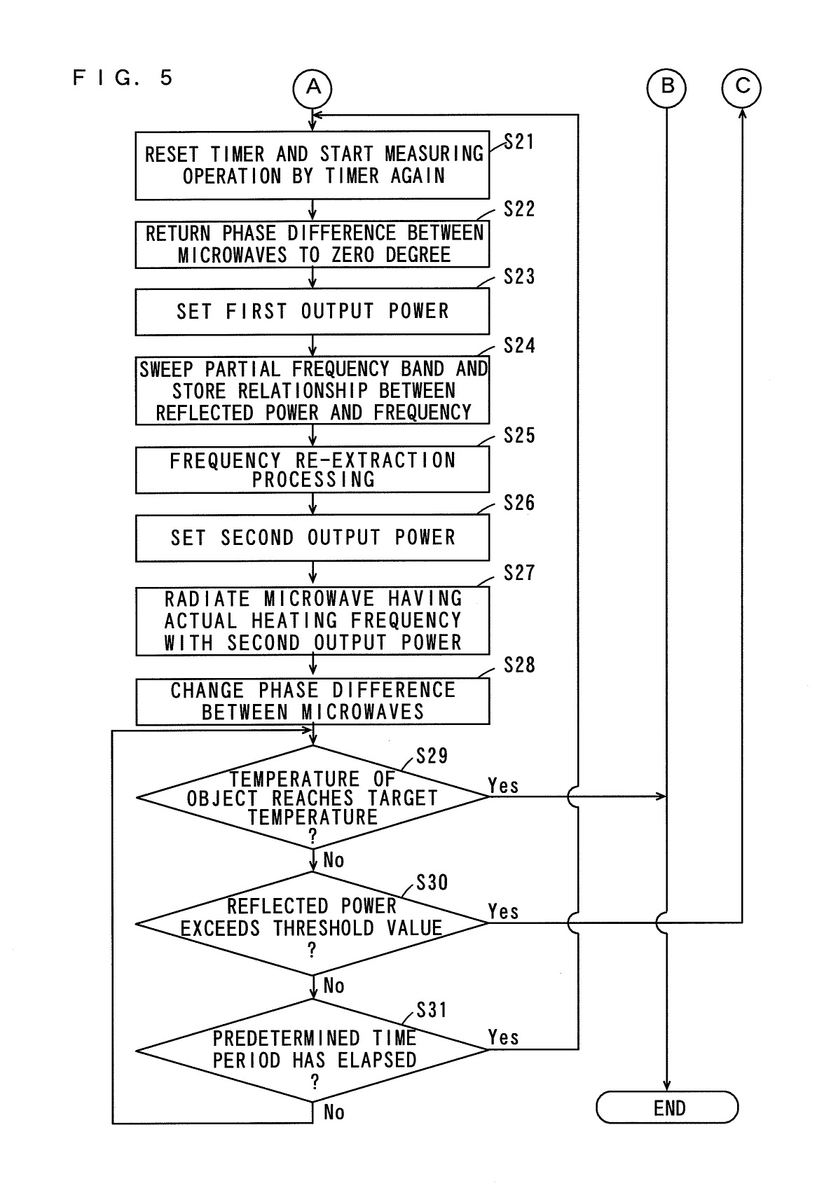

FIGS. 4 and 5 are flow charts showing the procedure for control by the microcomputer 700 shown in FIG. 1.

The microcomputer 700 shown in FIG. 1 is commanded to heat an object by a user's operation, to perform microwave processing, described below.

As shown in FIG. 4, the microcomputer 700 first causes a self-contained timer to start a measuring operation (step S11). The microcomputer 700 controls the microwave generator 300 shown in FIG. 1, to set a predetermined first output power as the output power of the microwave oven 1 (step S12). The first output power is less than a second output power, described later. A method of determining the first output power will be described later.

The microcomputer 700 then sweeps the frequency of the microwave generated by the microwave generator 300 over a full frequency band of 2400 MHz to 2500 MHz used in the microwave oven 1, and stores the relationship between a reflective power detected by each of the reflected power detection devices 600, 610, and 620 shown in FIG. 1 and the frequency (step S13). The frequency band is referred to as an ISM (Industrial Scientific and Medical) band.

Note that the microcomputer 700 may store only the relationship between the reflected power and the frequency in a case where the reflected power takes a minimal value instead of storing the relationship between the reflected power and the frequency in the full frequency band when the frequency of the microwave is swept. In this case, a used area of a storage in the microcomputer 700 can be reduced.

The microcomputer 700 then performs frequency extraction processing for extracting a particular frequency from the ISM band (step S14).

In the frequency extraction processing, the particular reflected power (e.g., the minimum value) is identified from the stored reflected powers, and the frequency at which the reflected power is obtained is extracted as an actual heating frequency, for example. This specific example will be described later.

When the microcomputer 700 stores a plurality of sets of relationships between the reflected power and the frequency only in a case where the reflected power takes a minimal value, the particular frequency is extracted out of the stored plurality of frequencies as an actual heating frequency.

The microcomputer 700 then sets a predetermined second output power as the output power of the microwave oven 1 (step S15).

The second output power is a power for heating an object arranged within the case 501 shown in FIG. 1, and corresponds to the maximum output power (rated output power) of the microwave oven 1. When the rated output power of the microwave oven 1 is 950 W, for example, the second output power is previously determined as 950 W.

The microcomputer 700 radiates the microwave having the actual heating frequency into the case 501 from the antennas A1, A2, and A3 using the second output power (step S16). This causes the object arranged within the case 501 to be heated (actual heating).

Here, the microcomputer 700 controls at least one of the phase variators 351a and 351b shown in FIG. 1, to continuously or gradually change a phase difference between the microwaves respectively radiated from the opposite two antennas A1 and A2 (step S17).

Thereafter, the microcomputer 700 determines whether or not the temperature of the object detected by the temperature sensor TS shown in FIG. 1 reaches a target temperature (e.g., 70° C.) (step S18). Note that the target temperature may be previously fixedly set, or may be optionally manually set by a user.

When the temperature of the object does not reach the target temperature, the microcomputer 700 determines whether or not the reflected power detected by the reflected power detection device 600 exceeds a predetermined threshold value (step S19). A method of determining the threshold value will be described later.

When the reflected power does not exceed the previously determined threshold value, the microcomputer 700 determines whether or not a predetermined time period (e.g., 10 seconds) has elapsed since the measuring operation of the timer was started in the step S11 (step S20).

Unless the predetermined time period has elapsed, the microcomputer 700 repeats the operations in the steps S18 to S20 while maintaining a state where the microwave having the actual heating frequency is radiated using the second output power.

When the temperature of the object reaches the target temperature in the step S18, the microcomputer 700 terminates microwave processing.

Furthermore, when the reflected power exceeds the predetermined threshold value in the step S19, the microcomputer 700 is returned to the operation in the step S11.

When a predetermined time period has elapsed in the step S20, the microcomputer 700 resets the timer as shown in FIG. 5, and starts the measuring operation of the timer again (step S21).

Here, the microcomputer 700 controls at least one of the phase variators 351a and 351b shown in FIG. 1, such that the phase difference between the microwaves respectively radiated from the opposite two antennas A1 and A2 is returned to be zero (step S22).

The microcomputer 700 sets the first output power as the output power of the microwave oven 1, as in the step S12 (step S23).

The microcomputer 700 then sets the actual heating frequency extracted in the step S16 as a reference frequency, partially sweeps the frequency of the microwave in a frequency band in a predetermined range including the reference frequency (e.g., a frequency band in a range of ±5 MHz from the reference frequency), and stores the relationship between the reflected power detected by the reflected power detection device 600 and the frequency (step S24).

The microcomputer 700 may store only the relationship between the reflected power and the frequency in a case where the reflected power takes a minimal value instead of storing the relationship between the reflected power and the frequency in the above-mentioned partial frequency band when the frequency of the microwave is swept. In this case, the used area of the storage in the microcomputer 700 can be reduced.

The frequency band serving as an object of sweeping in the step S24 is narrower than the frequency band serving as an object of sweeping in the step S13, i.e., the ISM band. Consequently, a time period required for the sweeping in the step S24 is made shorter, as compared with a time period required for the sweeping in the step S13.

The microcomputer 700 then performs frequency re-extraction processing for extracting the particular frequency again from the frequency band serving as the object of sweeping in the step S24 (step S25). The frequency re-extraction processing is the same as the frequency extraction processing in the step S14.

Furthermore, the microcomputer 700 sets the above-mentioned second output power as the output power of the microwave oven 1 (step S26).

The microcomputer 700 causes the antennas A1, A2 and A3 to radiate the microwave having the actual heating frequency newly extracted using the second output power into the case 501 (step S27).

Here, the microcomputer 700 controls at least one of the phase variators 351a and 351b shown in FIG. 1, to continuously or gradually change the phase difference between the microwaves respectively radiated from the opposite two antennas A1 and A2 (step S28), as in the operation in the step S17.

Thereafter, the microcomputer 700 performs operations in the steps S29 to S31, as in the foregoing steps S18 to S20. When the reflected power exceeds a predetermined threshold value in the step S30, the microcomputer 700 is returned to the operation in the step S11 shown in FIG. 4. When a predetermined time period has elapsed in the step S31, the microcomputer 700 is returned to the operation in the step S21.

(1-4) Phase Difference Between Microwaves Respectively Radiated from Opposite Antennas

As described in the foregoing, in the steps S17 and S28, the microcomputer 700 changes the phase difference between the microwaves respectively radiated from the opposite two antennas A1 and A2 at the time of actual heating of the object. The reason why the microcomputer thus carries out control will be described.

The two antennas A1 and A2 out of the three antennas A1, A2, and A3 within the case 501 are opposite each other in the horizontal direction, as described above. Thus, it is considered that on an axis connecting the opposite two antennas A1 and A2, the microwaves respectively radiated from the antennas A1 and A2 interfere with each other.

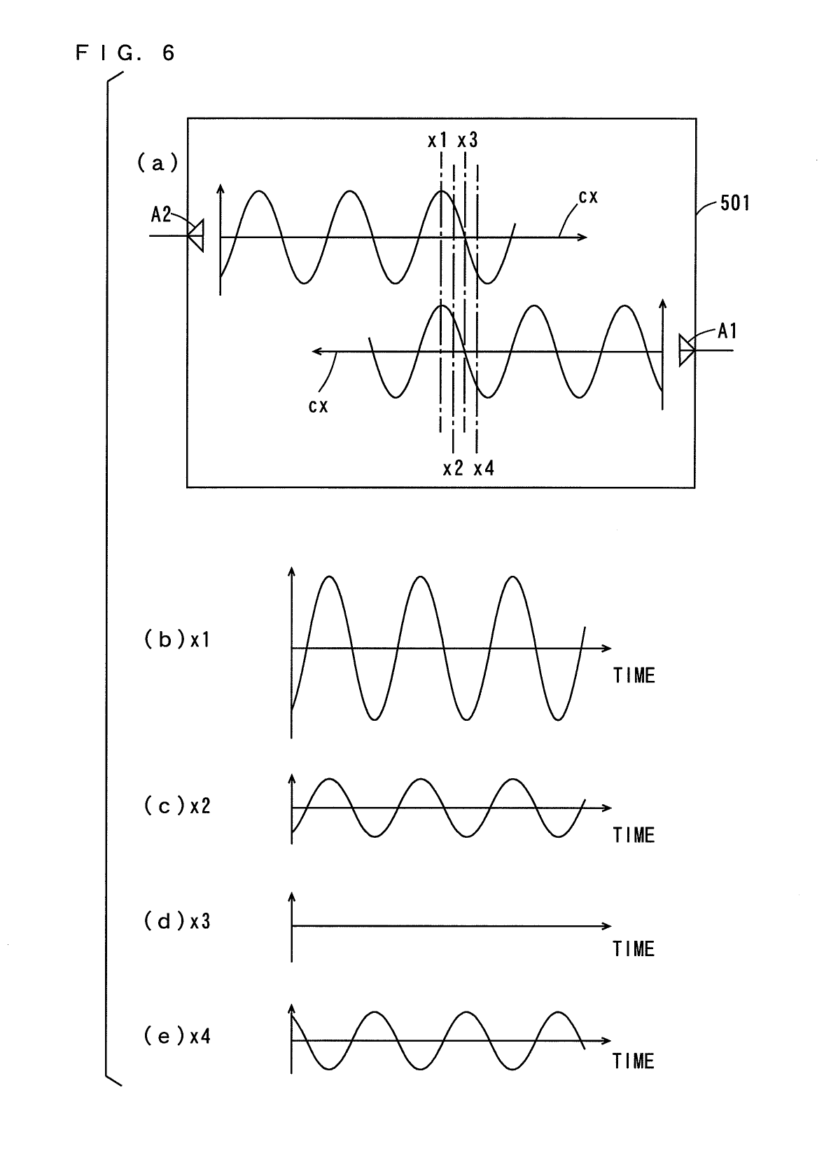

FIG. 6 is a diagram for explaining mutual interference between the microwaves respectively radiated from the antennas A1 and A2 shown in FIG. 1. FIG. 6 (a) illustrates a state where the microwaves are respectively radiated in the same phase (a phase difference of zero degree) from the antennas A1 and A2.

As shown in FIG. 6 (a), the intensities of the microwaves respectively radiated from the antennas A1 and A2 change in a sinusoidal shape. In FIG. 6 (a), the positions of the antennas A1 and A2 are respectively shifted in a longitudinal direction in order to clarify the intensities of the microwaves respectively radiated from the antennas A1 and A2.

FIGS. 6 (b), 6 (c), 6 (d), and 6 (e) show temporal changes in the intensities of microwaves at positions x1, x2, x3, and x4. The positions x1, x2, x3, and x4 are arranged on an axis cx connecting the antennas A1 and A2. In FIGS. 6 (b) to 6 (e), the vertical axis indicates the intensity of the microwave, and the horizontal axis indicates time.

The respective intensities of the microwaves at the positions x1 to x4 are obtained by synthesizing the microwaves respectively radiated from the antennas A1 and A2. Comparing FIGS. 6 (b) to 6 (e), the amplitude of the intensity of the microwave takes a maximum value at the position x1, is moderate at the positions x2 and x4, and is zero at the position x3.

In the microwave oven 1, the larger the amplitude of the intensity of the microwave is, the higher the rise in the temperature of the object becomes. On the other hand, the smaller the amplitude of the intensity of the microwave is, the lower the rise in the temperature of the object becomes.

Consequently, in this example, the temperature of the object can be most raised at the position x1, while being moderately raised at the positions x2 and x4. On the other hand, the temperature of the object can hardly be raised at the position x3.

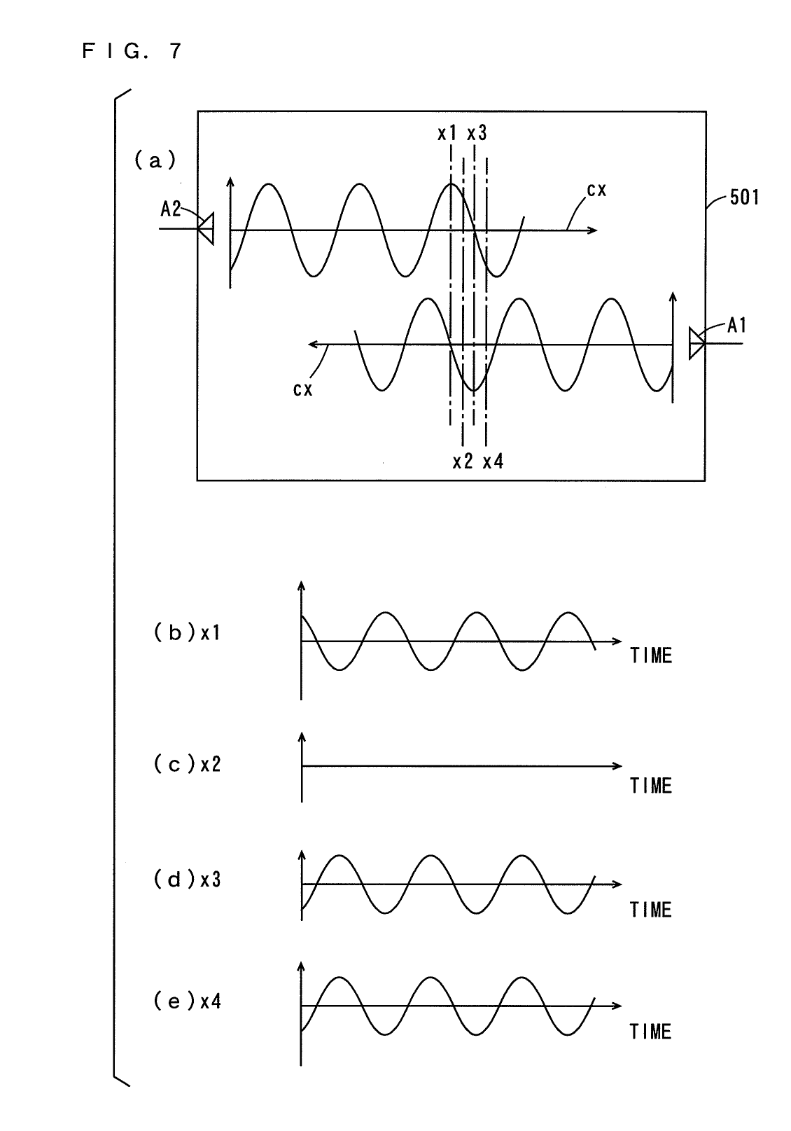

Here, suppose a case where the phase difference between the microwaves respectively radiated from the antennas A1 and A2 changes. FIG. 7 is a diagram for explaining mutual interference between the microwaves respectively radiated from the antennas A1 and A2 shown in FIG. 1 in a case where the phase difference therebetween changes.

When the phase difference between the microwaves respectively radiated from the antennas A1 and A2 changes, as shown in FIG. 7 (a), a state of the mutual interference between the microwaves respectively radiated from the antennas A1 and A2 also changes.

FIGS. 7 (b), 7 (c), 7 (d), and 7 (e) show temporal changes in the intensities of the microwaves at the positions x1, x2, x3, and x4. Also in FIGS. 7 (b) to 7 (e), the vertical axis indicates the intensity of the microwave, and the horizontal axis indicates time.

Comparing FIGS. 7 (b) to 7 (e), the amplitude of the intensity of the microwave is moderate at the positions x1, x3, and x4, while being zero at the position x2.

Consequently, in this case, the temperature of the object can be moderately raised at the positions x1, x3, and x4. On the other hand, the temperature of the object can hardly be raised at the position x2.

From the foregoing, the inventors have considered that the state of the mutual interference between the microwaves oppositely radiated can be easily changed by changing the phase difference between the microwaves and as a result, have considered that the distribution of the intensities of the microwaves (an electromagnetic wave distribution) within the microwave oven 1 can be easily changed by changing the phase difference between the microwaves.

Although description was made of the interference between the microwaves on the axis cx connecting the antennas A1 and A2, it is considered that the mutual interference between the microwaves respectively radiated from the antennas A1 and A2 occurs in a space around the axis cx connecting the antennas A1 and A2.

The inventors have conducted the following test in order to confirm that the non-uniformity of the electromagnetic wave distribution changes depending on the phase difference between the microwaves respectively radiated from the opposite two antennas A1 and A2.

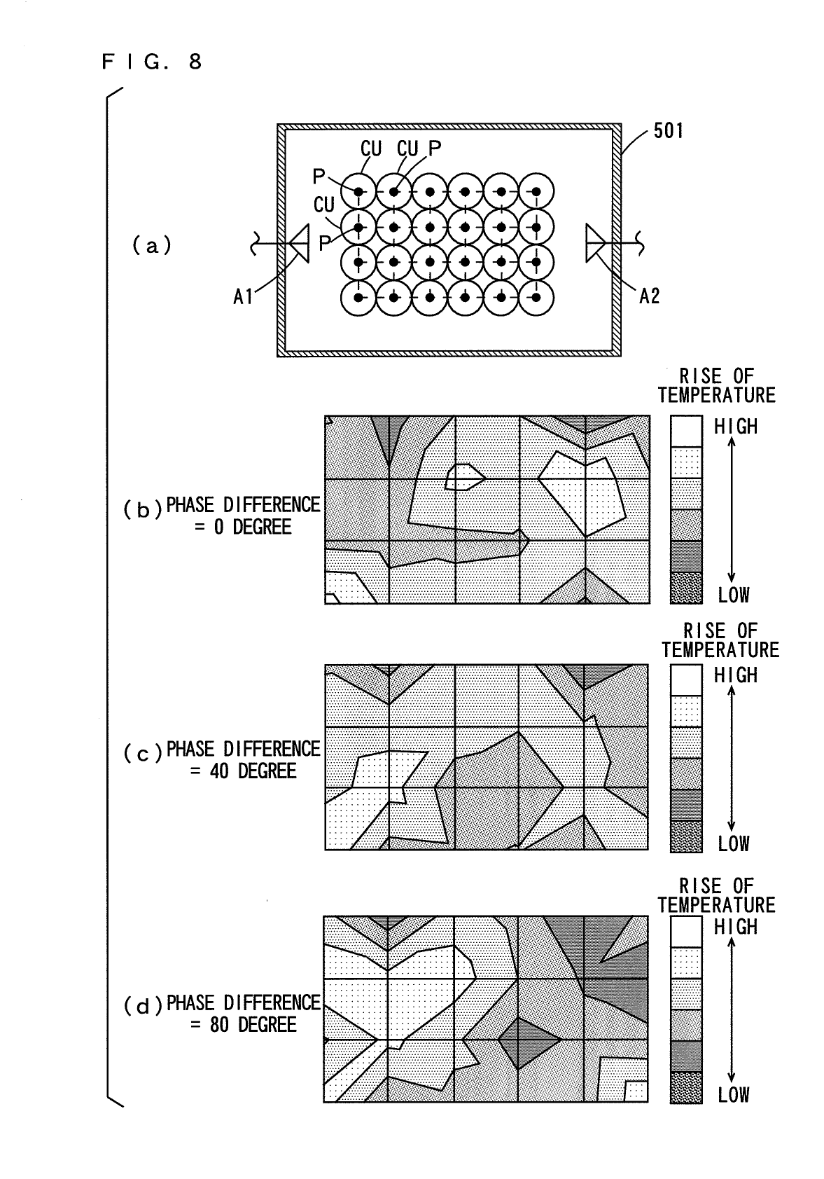

FIGS. 8 to 10 are diagrams showing the contents of an experiment for investigating the relationship between the phase difference between the microwaves respectively radiated from the opposite two antennas A1 and A2 and the electromagnetic wave distribution within the case 501 and the results of the experiment.

FIG. 8 (a) is a transverse sectional view of the case 501 shown in FIG. 1. In this experiment, a plurality of cups CU containing a predetermined amount of water were first arranged within the case 501.

The microwaves were respectively radiated from the opposite two antennas A1 and A2. Thereafter, the radiation of the microwaves was stopped with an elapse of a predetermined time period, and the rise in the temperature of water by the radiation of the microwaves was measured at the center of each of the cups CU (a point P in FIG. 8 (a)).

A plurality of phase differences were set between the microwave radiated from the antenna A1 and the microwave radiated from the antenna A2, and the microwaves were radiated a plurality of times for each of the set phase differences. In this experiment, the phase difference was set for 40 degrees from zero degree to 320 degrees.

Thus, the inventors have investigated the electromagnetic wave distribution of the microwaves by measuring the rise in the temperature of water arranged within a horizontal plane within the case 501. This experiment makes it possible to determine that the energy of the electromagnetic wave is high in a region where the rise in the temperature of water is high, while being low in a region where the rise in the temperature of water is low.

FIG. 8 (b) shows the results of the experiment in a case where the phase difference between the microwaves was set to zero degree using an isotherm based on the rise in the temperature of water. Similarly, FIGS. 8 (c) to 10 (j) show the results of the experiment in a case where the phase difference between the microwaves was set for 40 degrees from 40 degrees to 320 degrees.

Thus, the results of the experiment shown in FIG. 8 (b) to FIG. 10 (j) have shown that the rise in the temperature of water greatly varies within the case 501, and the change in the set phase difference causes the variation in the rise in the temperature to change.

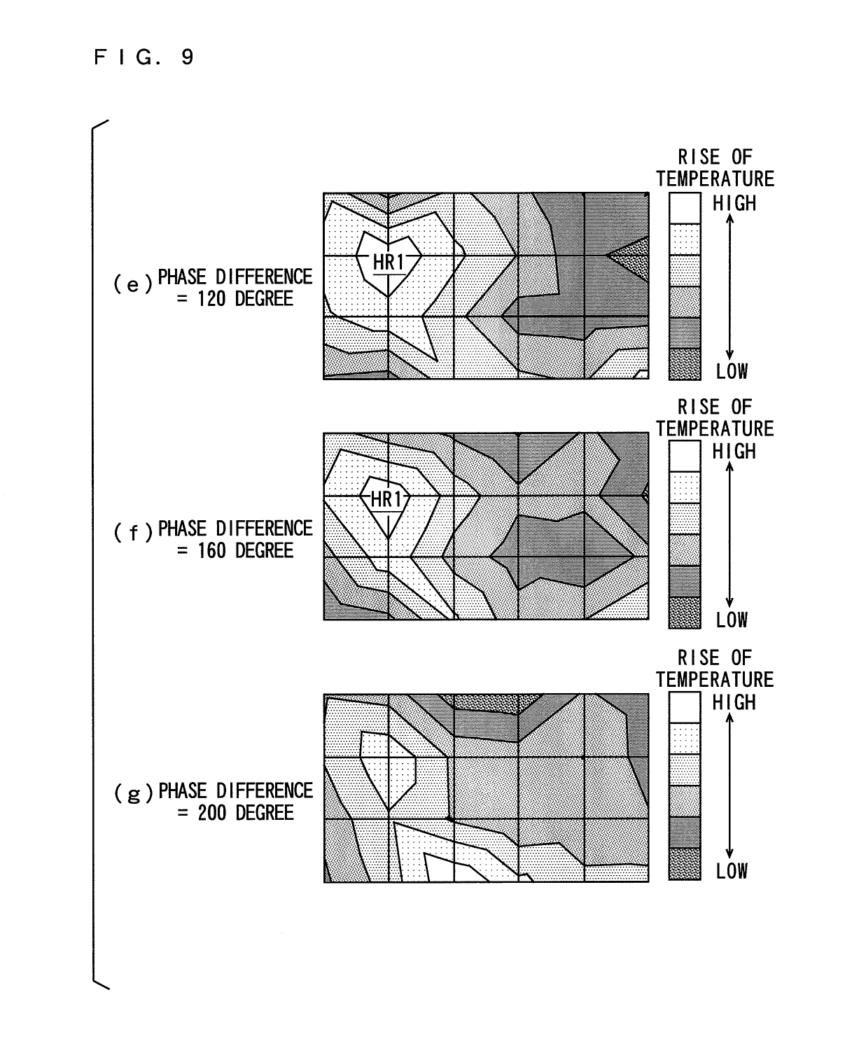

When the phase difference is set to 120 degrees and 160 degrees, as shown in FIGS. 9 (e) and 9 (f), for example, the rise in the temperature becomes significantly high in a region HR1 close to one side surface of the case 501.

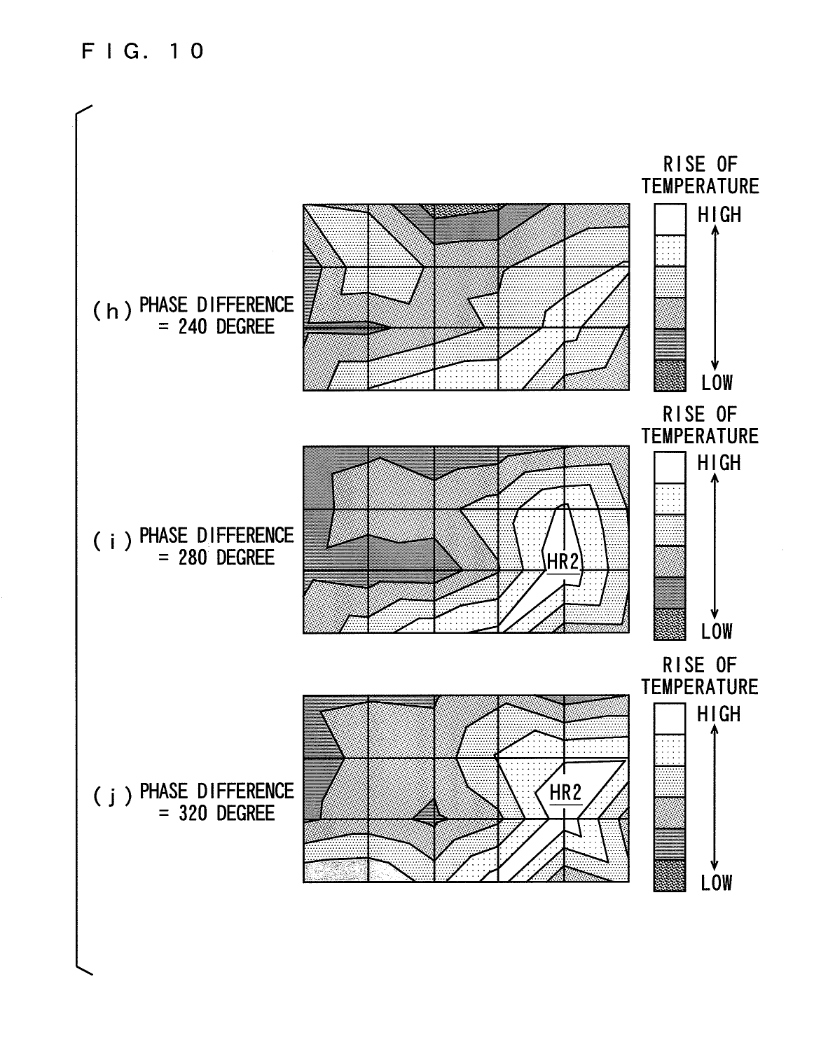

On the other hand, as shown in FIGS. 10 (i) and 10 (j), when the phase difference is set to 280 degrees and 320 degrees, the rise in the temperature becomes significantly high in a region HR2 close to the other side surface of the case 501.

This has made the inventors note that the non-uniformity of the electromagnetic wave distribution within the case 501 changes depending on the phase difference, to find out that it is possible to uniformly heat the object and to concentrically heat a particular portion of the object by changing the phase difference between the microwaves respectively radiated from the opposite two antennas A1 and A2 at the time of actual heating of the object.

In the present embodiment, the above-mentioned operations in the steps S17 and S28 allow the object arranged within the case 501 to be uniformly heated at the time of actual heating of the object.

Since the electromagnetic wave distribution within the case 501 can be changed by changing the phase difference, the object arranged within the case 501 need not be moved within the case 501. Furthermore, the necessity of moving the antenna for radiating the microwave in order to change the electromagnetic wave distribution is eliminated.

Therefore, the necessity of a mechanism for moving the object or the antenna as well as the necessity of getting a space for moving the object or the antenna within the case 501 are eliminated. As a result, the microwave oven 1 is made lower in cost and miniaturized.

In the present embodiment, it is assumed that the microcomputer 700 continuously or gradually changes the phase difference. When the phase difference is gradually changed, however, the phase difference may be changed for 40 degrees or may be changed for 45 degrees, for example. In this case, the phase difference that is changed per stage is not limited to the foregoing values. However, it is preferable that the phase difference is set to a value that is as low as possible. This allows non-uniform heating of the object to be further reduced.

The period of the change in the phase difference may be previously fixedly set or may be optionally manually set by the user.

When fixedly set, the period of the change in the phase difference may be changed from zero degree to 360 degrees in 30 seconds or may be changed from zero degree to 360 degrees in 10 seconds, for example.

The phase difference need not be necessarily changed from zero degree to 360 degrees. For example, the relationship between a plurality of values of the phase difference and electromagnetic wave distributions corresponding to the values is previously stored in a self-contained memory in the microcomputer 700.

In this case, the microcomputer 700 can selectively set the plurality of values of the phase difference depending on a state where the object is heated.

Specifically, a plurality of temperature sensors TS are arranged within the case 501. In this case, the temperature of the object can be measured with respect to a plurality of portions, so that the temperature distribution of the object can be known.

At this time, the microcomputer 700 sets the phase difference such that the energy of the electromagnetic wave is increased in a portion where the temperature of the object is low on the basis of the relationship between the values of the phase difference and the electromagnetic wave distributions, which is stored in the self-contained memory. This allows the object to be more uniformly heated.

(1-5) Method of Determining First Output Power

As described in the foregoing, in the microwave oven 1 shown in FIG. 1, the frequency of the microwave is swept using the first output power before the object is heated using the second output power, to perform the frequency extraction processing. The reason for this is as follows.

The reflected power generated by the radiation of the microwave changes depending on the frequency of the microwave. Here, when circuit elements respectively constituting the microwave generator 300 and the microwave amplifiers 400, 410, and 420 shown in FIG. 3 generate heat by the reflected power, the heat is radiated by the radiator fins 301 and 401 shown in FIG. 2. When the reflected power increases above the heat radiation capabilities of the radiator fins 301 and 401, the circuit elements respectively provided on the radiator fins 301 and 401 may be damaged by generating heat.

In the present embodiment, therefore, the first output power is determined such that the reflected power does not exceed the heat radiation capabilities of the radiator fins 301 and 401.

(1-6) Frequency Extraction Processing and Frequency Re-Extraction Processing

(1-6-a)

In the microwave oven 1 according to the present embodiment, processing for sweeping and extracting the frequency of the microwave before actual heating of the object (see steps S13 and 14 in FIG. 4).

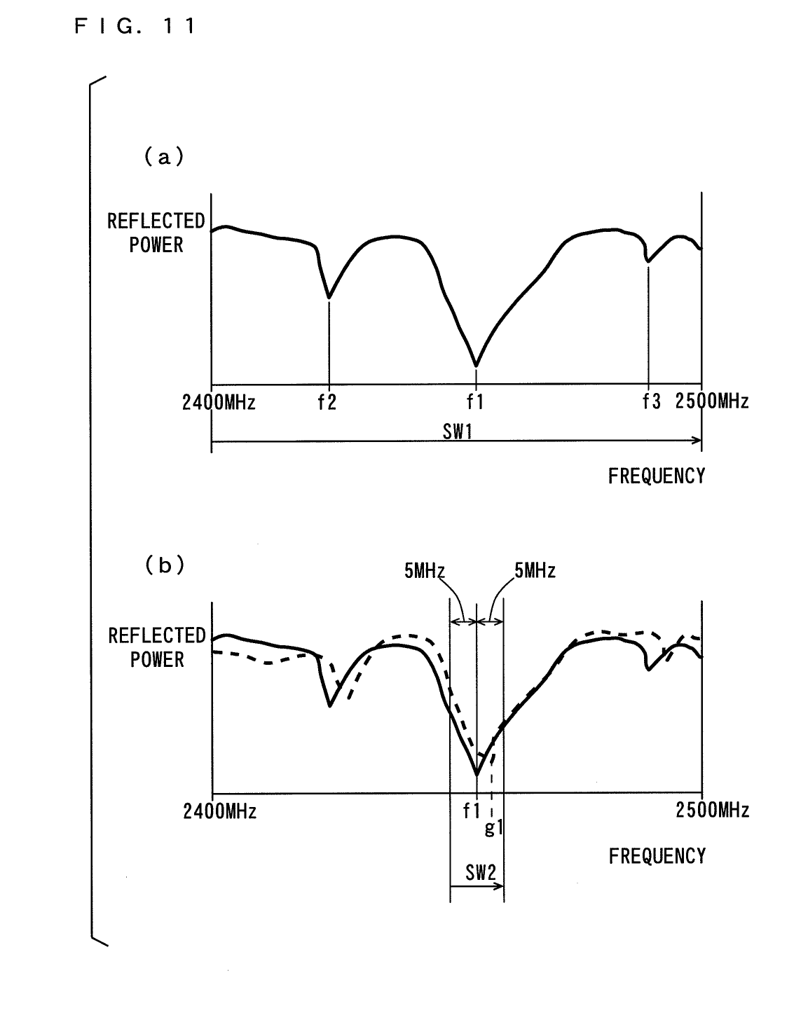

FIG. 11 is a diagram for explaining a specific example of processing for sweeping and extracting the frequency of the microwave.

FIG. 11 (a) graphically shows the change in the reflected power in a case where the frequency of the microwave is swept. In FIG. 11 (a), the vertical axis indicates the reflected power, and the horizontal axis indicates the frequency of the microwave.

In this example, only the reflected power in the antenna A1 shown in FIG. 1 is illustrated in FIG. 11 (a) in order to make description easy.

As described in the foregoing, in the microwave oven 1 according to the present embodiment, the frequency of the microwave is swept over a full ISM frequency band before actual heating of the object (see an arrow SW1). The microcomputer 700 stores the relationship between the reflected power and the frequency.

The microcomputer 700 extracts as an actual heating frequency a frequency f1 at which the reflected power takes a minimum value, for example, by the frequency extraction processing. Although in this example, only the reflected power in the antenna A1 is explained, all the reflected powers in the antennas A1, A2, and A3 are actually measured, and the frequency f1 at which the reflected power takes a minimum value is extracted as an actual heating frequency.

This causes the microwave having the actual heating frequency f1 to be radiated from the antennas A1 to the object within the case 501 using the second output power. As a result, the object can be heated while reducing the reflected power.

Note that the frequency of the microwave is swept 0.001 seconds per 0.1 MHz, for example. In this case, one second is required for the sweeping over the full ISM frequency band.

(1-6-b)

The change in the reflected power dependent on the frequency (hereinafter referred to as frequency characteristics of the reflected power) depends on the position, the size, the composition, the temperature, and so on of the object within the case 501. Consequently, when the object is heated by the microwave oven 1 and the temperature of the object rises, the frequency characteristics of the reflected power also change.

FIG. 11 (b) graphically shows the change in the frequency characteristics of the reflected power by heating of the object. In FIG. 11 (b), the vertical axis indicates the reflected power, and the horizontal axis indicates the frequency of the microwave. Further, the frequency characteristics of the reflected power at the time of sweeping before actual heating are indicated by a solid line, and the frequency characteristics of the reflected power in a case where the object is heated by actual heating are indicated by a broken line.

In the same manner as described above, only the reflected power in the antenna A1 shown in FIG. 1 is illustrated in FIG. 11 (b) in order to make description easy.

The frequency characteristics of the reflected power change, so that the frequency at which the reflected power takes minimum or minimal values changes. In FIG. 11 (b), g1 indicates the frequency at which the reflected power takes a minimum value when the object is heated.

Thus, the frequency characteristics of the reflected power also change depending on the temperature of the object. In the microwave oven 1 according to the present embodiment, therefore, processing for sweeping and re-extracting the frequency of the microwave is performed for each elapse of a predetermined time period when the object is subjected to actual heating (see steps S24 and S25 in FIG. 5).

However, the frequency of the microwave is swept at this time in a frequency band in a range of ±5 MHz with a frequency f1 set at the time of actual heating immediately before the sweeping used as a reference frequency (see an arrow SW2). This causes the frequency g1 at which the reflected power takes a minimum value to be extracted again as a new actual heating frequency.

The frequency of the microwave is swept in a partial frequency band in a predetermined range including the actual heating frequency set immediately before the sweeping, which causes a time period required for the sweeping to be shortened. When the frequency of the microwave is swept 0.001 seconds per 0.1 MHz, for example, a time period required for the sweeping in the frequency band in a range of ±5 MHz from the reference frequency is 0.1 seconds.

Although in the present embodiment, the processing for sweeping and re-extracting the frequency in the partial frequency band is performed at predetermined time intervals, it is preferable that the time intervals are set to 10 seconds, for example, such that the frequency characteristics of the reflected power do not greatly change by heating the object.

(1-7) Threshold Value of Reflected Power

In the microwave oven 1 according to the present embodiment, it is determined whether or not the reflected power exceeds a predetermined threshold value at the time of actual heating of the object (see steps S18 in FIG. 4 and step S30 in FIG. 5).

Here, the threshold value is determined to a value obtained by adding 50 W to the minimum value of the reflected power detected at the time of the frequency extraction processing, for example. When the reflected power increases above 50 W from its value at the start of actual heating, therefore, the microcomputer 700 sweeps the frequency of the microwave over the full ISM frequency band, to perform the frequency extraction processing.

This can prevent the reflected power from significantly increasing during actual heating of the object. Even when the frequency characteristics of the reflected power greatly changes by heating the object, the frequency of the microwave is swept over the full ISM frequency band, so that the frequency extraction processing is performed. This allows the reflected power to be always reduced.

(1-8) Another Example of Frequency Extraction Processing

The frequency extraction processing may be performed in the following manner. As shown in FIG. 11 (a), the frequency characteristics of the reflected power may, in some cases, have a plurality of minimal values, for example. At this time, the microcomputer 700 may extract the frequencies f1, f2, and f3 respectively corresponding to the plurality of minimal values may be extracted as actual heating frequencies.

In this case, the microcomputer 700 may switch the actual heating frequencies f1, f2, and f3 in this order. For example, the microcomputer 700 switches the actual heating frequencies f1, f2, and f3 in this order for three seconds from the start of actual heating of the object.

When a plurality of minimal values at the same level exist at the time of sweeping by actual heating at the plurality of frequencies corresponding to the plurality of minimal values, therefore, the object can be subjected to actual heating using the microwave having the frequency corresponding to each of the minimal values.

(1-9) Effects

(1-9-a)

In the microwave oven 1 according to the present embodiment, the phase difference between the microwaves respectively radiated from the opposite two antennas A1 and A2 changes at the time of actual heating of the object. This causes the object arranged within the case 501 to be uniformly heated.

Since the electromagnetic wave distribution within the case 501 can be changed by changing the phase difference, the object need not be moved within the case 501. Further, the antenna for radiating the microwave need not be also moved in order to change the electromagnetic wave distribution.

This eliminates the necessity of a mechanism for moving the object or the antenna and eliminates the necessity of getting a space for moving the object or the antenna within the case 501. As a result, the microwave oven 1 is made lower in cost and miniaturized.

(1-9-b)

As shown in FIG. 1, the antenna A3 is provided, in addition to the opposite two antennas A1 and A2, with the antenna A3 not opposite to the antenna A1 and A2 within the case 501 in the microwave oven 1. The reason for this is as follows.

The microwave has directivity. Consequently, the arrangement state or the shape of the object within the case 501 cannot, in some cases, efficiently heat the object using the microwaves respectively radiated from the antennas A1 and A2.

Consequently, the antenna A3 that radiates the microwave vertically upward from below is provided in addition to the antennas A1 and A2 that radiate the microwaves along the horizontal direction in this example. This allows the object to be efficiently heated irrespective of the directivity of the microwave.

(1-9-c)

In the microwave oven 1 according to the present embodiment, the frequency of the microwave at which the reflected power generated when the object is heated takes a minimum value is extracted by frequency extraction processing before the object is subjected to actual heating. The extracted frequency is used as the actual heating frequency, which causes the power conversion efficiency of the microwave oven 1 to be improved.

Furthermore, in the frequency extraction processing, the output power of the microwave oven 1 is set to the first output power sufficiently lower than that at the time of the actual heating. This causes the radiator fins 301 and 401 to sufficiently radiate heat even when the circuit elements respectively constituting the microwave oven 300 and the microwave amplifier 400 generate heat by the reflected power when the frequency of the microwave is swept.

As a result, the circuit elements respectively provided on the radiator fins 301 and 401 are reliably prevented from being damaged by the reflected power.

(1-9-d)

In the present embodiment, the two antennas A1 and A2 opposite each other along the horizontal direction are provided slightly below the center in the vertical direction of the case 501, as shown in FIG. 1. This allows the object arranged in a lower part of the case 501 to be efficiently heated when the microwave oven 1 is employed.

(1-10) Modification

Although in the first embodiment, the microcomputer 700 changes the phase difference between the microwaves respectively radiated from the opposite antennas A1 and A2 for each start of the actual heating using the second output power (see step S17 in FIG. 4), and the phase difference between the microwaves is returned to zero every time the actual heating is stopped (see step S22 in FIG. 5), the phase difference need not be necessarily returned to zero. The microcomputer 700 may set the phase difference to a predetermined value in the step S22.

Although in the present embodiment, description was made of an example in which the phase difference between the microwaves at the time of actual heating of the object is changed to uniformly heat the object, the relationship between the phase difference and the electromagnetic wave distribution may be previously stored in the self-contained memory in the microcomputer 700, to change the phase difference on the basis of the relationship to concentrically heat a desired portion of the object.

For example, the phase difference is so set that the electromagnetic field is intense at a substantially central part of a portion where the object is placed within the case 501. In this case, even a small object can be efficiently heated.

Although the second output power is taken as the maximum output power of the microwave oven 1, the second output power may be optionally manually set by the user.

Although in the present embodiment, the microcomputer 700 determines that the microwave processing is terminated on the basis of a measured value of the temperature of the object, which is measured by the temperature sensor TS shown in FIG. 1, the microwave processing may be terminated on the basis of its termination time manually set by the user.

In the microwave oven 1 according to the present embodiment, if the mutual interference occurs between the microwaves respectively radiated from the antennas A1 and A2, the antennas A1 and A2 need not necessarily be opposite each other.

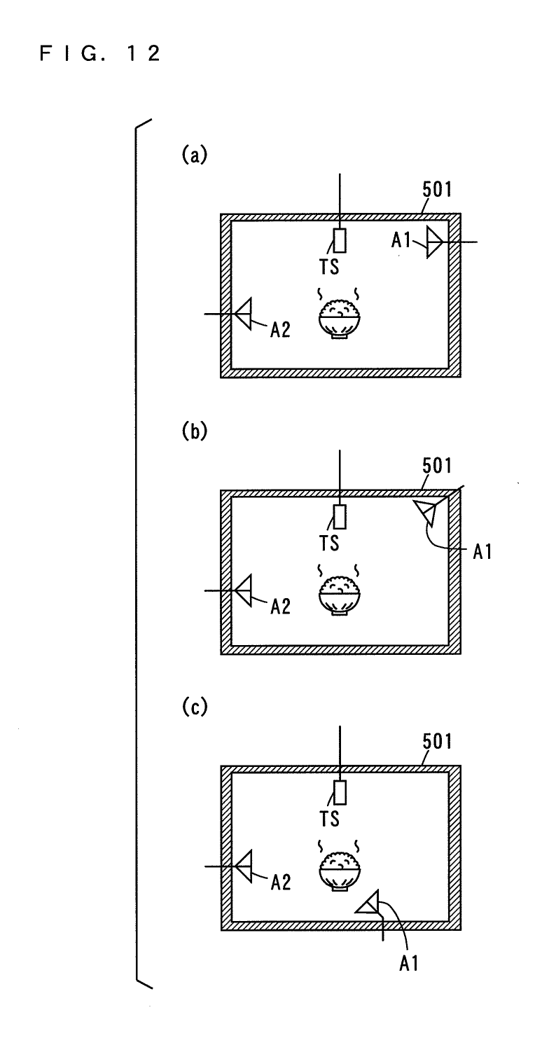

FIG. 12 is a diagram showing other examples of the arrangement of the antennas A1 and A2 shown in FIG. 1. In the example shown in FIG. 12 (a), the antenna A1 is horizontally arranged on an upper part of one side surface of the case 501, and the antenna A2 is horizontally arranged on a substantially central part of the other side surface of the case 501.

In the example shown in FIG. 12 (b), the antenna A1 is arranged on an upper part of the one side surface of the case 501 so as to be directed toward a substantially central part of a lower surface of the case 501, and the antenna A2 is horizontally arranged on a substantially central part of the other side surface of the case 501.

In the example shown in FIG. 12 (c), the antenna A1 is arranged on a substantially central part of the lower surface of the case 501 so as to be inclined toward the other side surface of the case 501, and the antenna A2 is horizontally arranged on a substantially central part of the other side surface of the case 501.

In these cases, the microwaves are also respectively radiated from the antennas A1 and A2, so that the mutual interference occurs between both the microwaves. As a result, the electromagnetic wave distribution within the case 501 changes by changing the phase difference between both the microwaves.

### [2] Second Embodiment

A microwave oven according to a second embodiment differs from the microwave oven 1 according to the first embodiment in the following points.

(2-1) Outline of Configuration and Operations of Microwave Oven

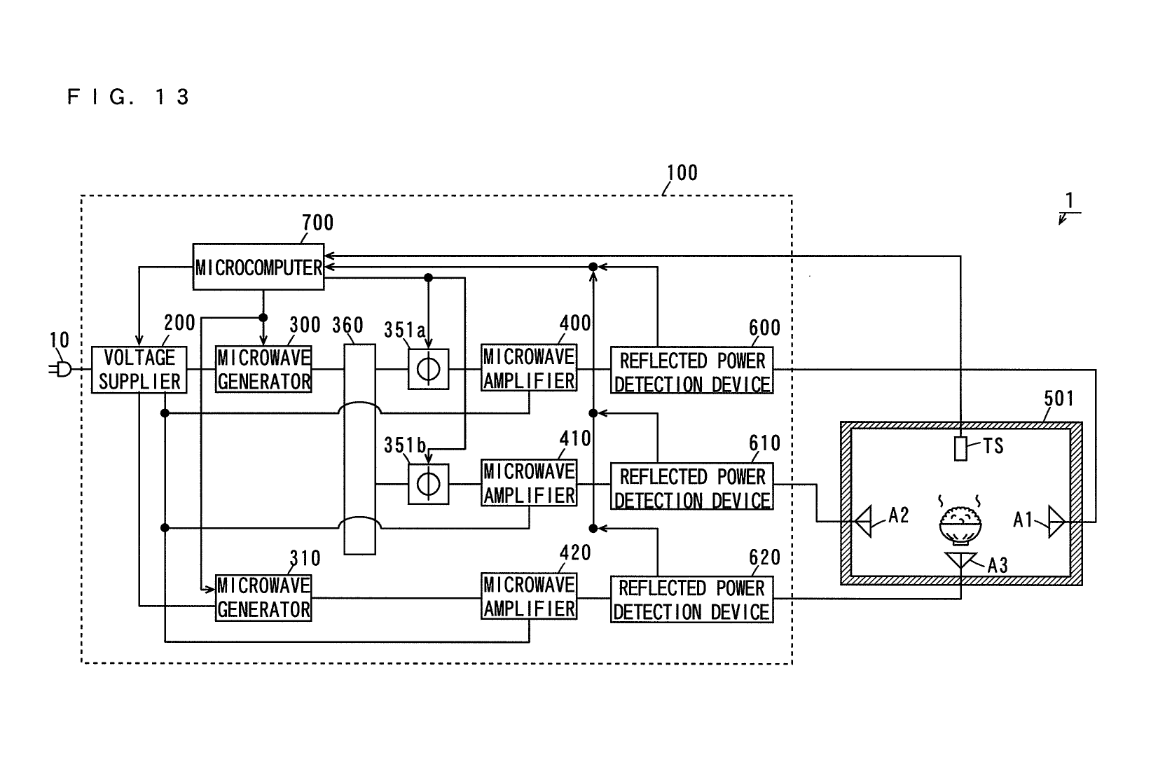

FIG. 13 is a block diagram showing the configuration of the microwave oven according to the second embodiment. As shown in FIG. 13, a microwave oven 1 according to the second embodiment differs from the microwave oven 1 (FIG. 1) according to the first embodiment in the configuration of a microwave generation device 100.

In the microwave oven 1 according to the present embodiment, the microwave generation device 100 includes a voltage supplier 200, two microwave generators 300 and 310 having the same configuration, a power distributor 360, two phase variators 351a and 351b having the same configuration, three microwave amplifiers 400, 410, and 420 having the same configuration, three reflected power detection devices 600, 610, and 620 having the same configuration, and a microcomputer 700.

Here, the configuration of the microwave generator 310 is the same as that of the microwave generator 300 described in the first embodiment.

A power supply plug 10 is connected to a commercial power supply, so that an AC voltage is supplied to the voltage supplier 200.

The voltage supplier 200 converts the AC voltage supplied from the commercial power supply into a variable voltage and a DC voltage, and feeds the variable voltage to the microwave generators 300 and 310, while feeding the DC voltage to the microwave amplifiers 400, 410, and 420.

The microwave generator 300 generates a microwave on the basis of the variable voltage supplied from the voltage supplier 200. The power distributor 360 almost equally distributes the microwave generated by the microwave generator 300 between the phase variators 351a and 351b.

Each of the phase variators 351a and 351b is controlled by the microcomputer 700, to adjust the phase of the fed microwave. The adjustment of the phase of the microwave by each of the phase variators 351a and 351b is the same as that in the first embodiment.

The microwave amplifiers 400 and 410 are operated by the DC voltage supplied from the voltage supplier 200, to respectively amplify microwaves fed from the phase variators 351a and 351b. The amplified microwaves are respectively fed to antennas A1 and A2 opposite each other along a horizontal direction within a case 501 through the reflected power detection devices 600 and 610.

The microwave generator 310 also generates a microwave on the basis of the variable voltage supplied from the voltage supplier 200. The microwave generated by the microwave generator 310 is fed to the microwave amplifier 420.

The microwave amplifier 420 is operated by the DC voltage supplied from the voltage supplier 200, to amplify the microwave generated by the microwave generator 300. The amplified microwave is supplied to an antenna A3 in the case 501 through the reflected power detection device 620.

(2-2) Effects

As described in the foregoing, in the present embodiment, a generation source (the microwave generator 310) of a microwave radiated from the antenna A3 differs from a generation source (the microwave generator 300) of microwaves respectively radiated from the opposite antennas A1 and A2.

This allows the frequency of the microwave radiated from the antenna A3 to be controlled to a frequency different from the frequencies of the microwaves respectively radiated from the other antennas A1 and A2. This allows the power conversion efficiency to be further improved.

The configurations of a power distributor and a phase variator need not be provided in a transmission path of the microwave radiated from the antenna A3. This causes the configuration of the microwave oven 1 to be simplified, so that the microwave oven 1 is made lower in cost and miniaturized.

### [3] Third Embodiment

A microwave oven according to a third embodiment differs from the microwave oven 1 according to the first embodiment in the following points.

(3-1) Outline of Configuration and Operations of Microwave Oven

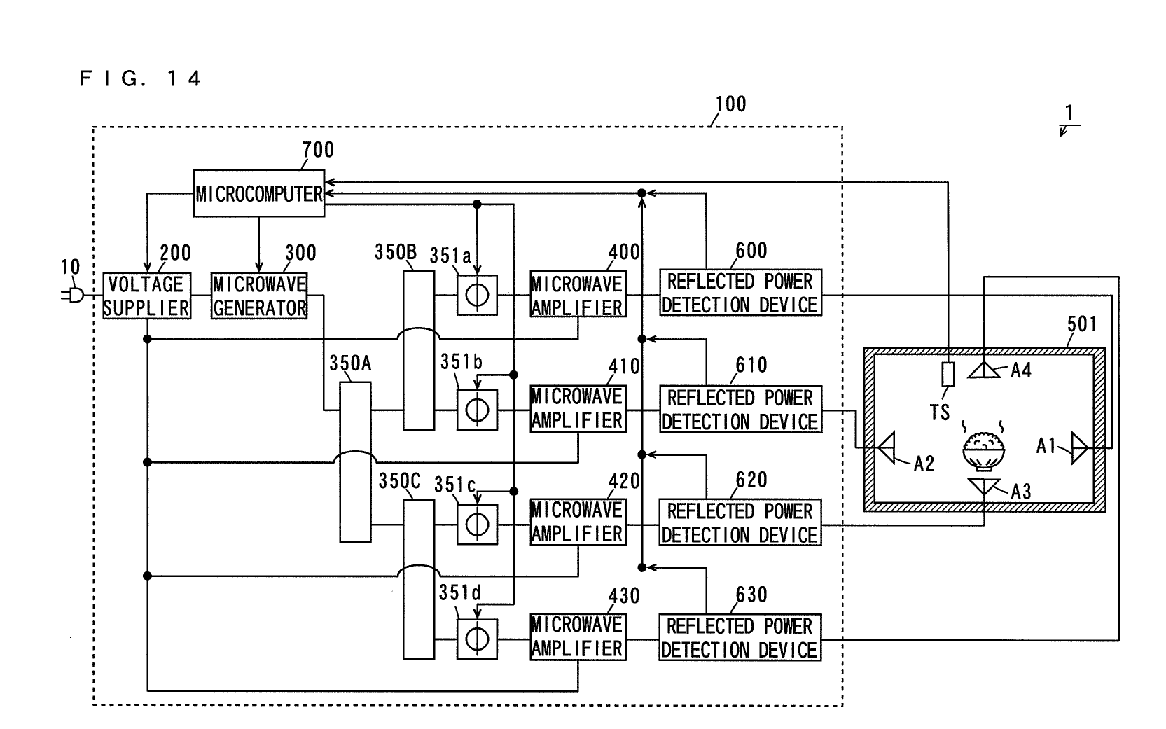

FIG. 14 is a block diagram showing the configuration of the microwave oven according to the third embodiment. As shown in FIG. 14, a microwave oven 1 according to the third embodiment differs from the microwave oven 1 (FIG. 1) according to the first embodiment in the configuration of a microwave generation device 100.

In the microwave oven 1 according to the present embodiment, the microwave generation device 100 includes a voltage supplier 200, a microwave generator 300, three power distributors 350A, 350B, and 350C having the same configuration, four phase variators 351a, 351b, 351c, and 351d having the same configuration, four microwave amplifiers 400, 410, 420, and 430 having the same configuration, four reflected power detection devices 600, 610, 620, and 630 having the same configuration, and a microcomputer 700.

A power supply plug 10 is connected to a commercial power supply, to supply an AC voltage to the voltage supplier 200.

The voltage supplier 200 converts the AC voltage supplied from the commercial power supply into a variable voltage and a DC voltage, and feeds the variable voltage to the microwave generator 300, while feeding the DC voltage to the microwave amplifiers 400, 410, 420, and 430.

The microwave generator 300 generates a microwave on the basis of the variable voltage supplied from the voltage supplier 200, and feeds the microwave to the power distributor 350A.

The power distributor 350A almost equally distributes the fed microwave between the power distributors 350B and 350C. The power distributor 350B almost equally distributes the fed microwave between the phase variators 351a and 351b. The power distributor 3500 almost equally distributes the fed microwave between the phase variators 351c and 351d.

Each of the phase variators 351a, 351b, 351c, and 351d is controlled by the microcomputer 700, to adjust the phase of the fed microwave. The details will be described later.

The microwave amplifiers 400 and 410 are operated by the DC voltage supplied from the voltage supplier 200, to respectively amplify microwaves fed from the phase variators 351a and 351b. The amplified microwaves are respectively fed to antennas A1 and A2 opposite each other along a horizontal direction within a case 501 through the reflected power detection devices 600 and 610.

Furthermore, the microwave amplifiers 420 and 430 are also operated by the DC voltage supplied from the voltage supplier 200, to respectively amplify microwaves fed from the phase variators 351c and 351d. The amplified microwaves are respectively fed to antennas A3 and A4 opposed to each other along a vertical direction within the case 501 through the reflected power detection devices 620 and 630.

(3-2) Adjustment of Phase of Microwave

As shown in FIG. 14, in the case 501, the antennas A1 and A2 are opposite each other along the horizontal direction, and the antennas A3 and A4 are opposite each other along the vertical direction.

Here, a transmission path of a microwave radiated from the antenna A1 is provided with the phase variator 351a, and a transmission path of a microwave radiated from the antenna A2 is provided with the phase variator 351b.

Furthermore, a transmission path of a microwave radiated from the antenna A3 is provided with the phase variator 351c, and a transmission path of a microwave radiated from the antenna A4 is provided with the phase variator 351d.

Thus, in the present embodiment, the microcomputer 700 performs the same processing as that in the first embodiment with respect to the two phase variators 351a and 351b respectively corresponding to the opposite antennas A1 and A2. That is, the microcomputer 700 changes a phase difference between the microwaves respectively radiated from the opposite two antennas A1 and A2 at the time of actual heating of an object.

Furthermore, the microcomputer 700 performs the same processing as that in the first embodiment with respect to the two phase variators 351c and 351d respectively corresponding to the opposite antennas A3 and A4. That is, the microcomputer 700 changes a phase difference between the microwaves respectively radiated from the opposite two antennas A3 and A4 at the time of actual heating of the object.

(3-3) Effects

In the present embodiment, the phase difference between the microwaves respectively radiated from the antennas A1 and A2 opposite each other along the horizontal direction is changed, and the phase difference between the microwaves respectively radiated from the antennas A3 and A4 opposite each other along the vertical direction is also changed. Thus, an electromagnetic wave distribution within the case 501 is sufficiently changed, which causes the object arranged within the case 501 to be more uniformly heated.

In the present embodiment, the object arranged within the case 501 is heated by the microwaves respectively radiated from the antennas A1 and A2 opposite each other along the horizontal direction, and is heated by the microwaves respectively radiated from the antennas A3 and A4 opposite each other along the vertical direction. This allows the object to be sufficiently efficiently heated irrespective of the directivity of the microwaves.

### [4] Fourth Embodiment

A microwave oven according to a fourth embodiment differs from the microwave oven 1 according to the first embodiment in the following points.

(4-1) Outline of Configuration and Operations of Microwave Oven

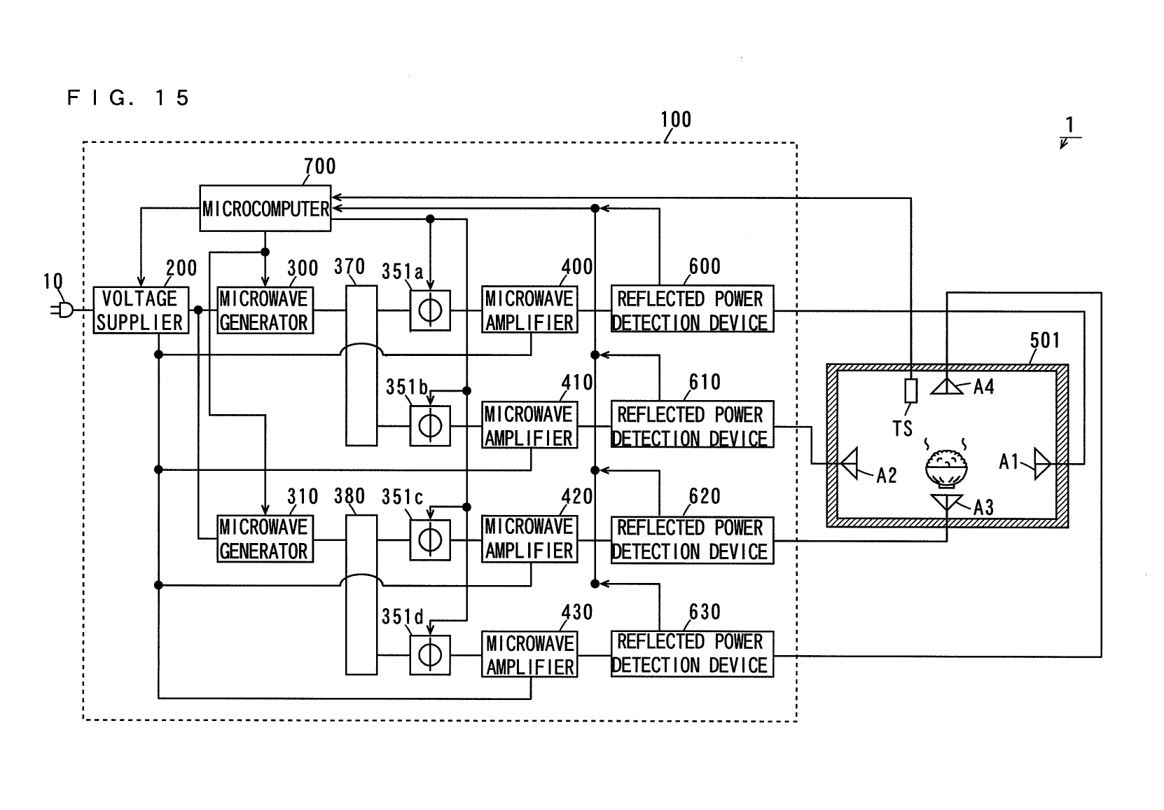

FIG. 15 is a block diagram showing the configuration of the microwave oven according to the fourth embodiment. As shown in FIG. 15, a microwave oven 1 according to the fourth embodiment differs from the microwave oven 1 (FIG. 1) according to the first embodiment in the configuration of a microwave generation device 100.

In the microwave oven 1 according to the present embodiment, the microwave generation device 100 includes a voltage supplier 200, microwave generators 300 and 310, two power distributors 370 and 380 having the same configuration, four phase variators 351a, 351b, 351c, and 351d having the same configuration, four microwave amplifiers 400, 410, 420, and 430 having the same configuration, four reflected power detection devices 600, 610, 620, and 630 having the same configuration, and a microcomputer 700.

A power supply plug 10 is connected to a commercial power supply, to supply an AC voltage to the voltage supplier 200.

The voltage supplier 200 converts the AC voltage supplied from the commercial power supply into a variable voltage and a DC voltage, and feeds the variable voltage to the microwave generators 300 and 310, while feeding the DC voltage to the microwave amplifiers 400, 410, 420, and 430.

The microwave generator 300 generates a microwave on the basis of the variable voltage supplied from the voltage supplier 200, and feeds the microwave to the power distributor 370. The power distributor 370 almost equally distributes a microwave generated by the microwave generator 300 between the phase variators 351a and 351b.

The microwave generator 310 generates a microwave on the basis of the variable voltage supplied from the voltage supplier 200, and feeds the microwave to the power distributor 380. The power distributor 380 almost equally distributes a microwave generated by the microwave generator 310 between the phase variators 351c and 351d.

Each of the phase variators 351a, 351b, 351c, and 351d is controlled by the microcomputer 700, to adjust the phase of the fed microwave.

Here, the adjustment of the phase of the microwave by each of the phase variators 351a, 351b, 351c, and 351d is the same as that in the third embodiment.

The microwave amplifiers 400 and 410 are operated by the DC voltage supplied from the voltage supplier 200, to respectively amplify microwaves respectively fed from the phase variators 351a and 351b. The amplified microwaves are respectively fed to antennas A1 and A2 opposite each other along a horizontal direction within a case 501 through the reflected power detection devices 600 and 610.

Furthermore, the microwave amplifiers 420 and 430 are also operated by the DC voltage supplied from the voltage supplier 200, to respectively amplify microwaves fed from the phase variators 351c and 351d. The amplified microwaves are respectively fed to antennas A3 and A4 opposite each other along a vertical direction within the case 501 through the reflected power detection devices 620 and 630.

(4-2) Effects

Even in the present embodiment, a phase difference between the microwaves respectively radiated from the antennas A1 and A2 opposite each other along the horizontal direction is changed, and a phase difference between the microwaves respectively radiated from the antennas A3 and A4 opposite each other along the vertical direction is also changed. Thus, an electromagnetic wave distribution within the case 501 is sufficiently changed, which causes an object arranged within the case 501 to be more uniformly heated. This allows the object to be sufficiently efficiently heated irrespective of the directivity of the microwaves.

In the present embodiment, a generation source (the microwave generator 300) of the microwaves respectively radiated from the antenna A1 and A2 differs from a generation source (the microwave generator 310) of the microwaves respectively radiated from the antennas A3 and A4.

This allows the frequencies of the microwaves respectively radiated from the antennas A1 and A2 to be controlled to frequencies different from the frequencies of the microwaves respectively radiated from the other antennas A3 and A4. This allows the power conversion efficiency to be further improved.

### [5] Correspondences Between Elements in the claims and Parts in Embodiments

In the following paragraphs, non-limiting examples of correspondences between various elements recited in the claims below and those described above with respect to various preferred embodiments of the present invention are explained.

In the first to fourth embodiments described above, the microwave oven 1 is an example of a microwave processing apparatus, the microwave generators 300 and 310 are examples of a microwave generator, the antenna A1 is an example of a first radiator, and the antenna A2 is an example of a second radiator.

The phase variators 351a and 351b are examples of a first phase variator, the reflected power detection devices 600, 610, 620, and 630 are examples of a detector, and the microcomputer 700 is an example of a controller.

Furthermore, the antenna A3 is an example of a third radiator, the microwave generator 300 is an example of a first microwave generator, the microwave generator 310 is an example of a second microwave generator, the antenna A4 is an example of a fourth radiator, and the phase variators 351c and 351d are examples of a second phase variator.

### INDUSTRIAL APPLICABILITY

The present invention is applicable to processing apparatuses that generate microwaves, for example, a microwave oven, a plasma generation apparatus, a drying apparatus, and an apparatus for promoting an oxygen reaction.

1. A microwave processing apparatus that processes an object using a microwave, comprising:
a microwave generator that generates a microwave; and
at least first and second radiators that radiate to the object the microwave generated by said microwave generator,
wherein a phase difference between microwaves respectively radiated from said first and second radiators changes.

2. A microwave processing apparatus that processes an object using a microwave, comprising:
a microwave generator that generates a microwave;
first and second radiators that respectively radiate to the object the microwave generated by said microwave generator; and
a first phase variator that changes a phase difference between microwaves respectively radiated from said first and second radiators,
wherein said first and second radiators are arranged such that the radiated microwaves interfere with each other.

3. The microwave processing apparatus according to claim 1, wherein said first and second radiators are opposite each other.

4. The microwave processing apparatus according to claim 1, further comprising:
a detector that detects respective reflected powers from said first and second radiators, and
a controller that controls said microwave generator,
wherein said controller causes said first and second radiators to radiate the microwaves to the object while changing the frequency of the microwave generated by said microwave generator, determines the frequency of the microwave for processing the object as a processing frequency on the basis of a frequency at which the reflected power detected by said detector take a minimum or minimal value, and causes said microwave generator to generate the microwave having the determined processing frequency.

5. The microwave processing apparatus according to claim 4, wherein said controller causes said first and second radiators to radiate the microwaves to the object while changing the frequency of the microwave generated by said microwave generator before the object is processed, and determines the frequency of the microwave for processing the object as a processing frequency on the basis of the frequency at which the reflected power detected by said detector take a minimum or minimal value.

6. The microwave processing apparatus according to claim 4, wherein said controller causes said first and second radiators to radiate the microwaves to the object while changing the frequency of the microwave generated by said microwave generator while the object is processed, and determines the frequency of the microwave for processing the object as a processing frequency on the basis of the frequency at which the reflected power detected by said detector take a minimum or minimal value.

7. The microwave processing apparatus according to claim 1, wherein said first radiator radiates the microwave along a first direction, and said second radiator radiates the microwave along a second direction opposite to said first direction, further comprising:
a third radiator that radiates the microwave generated by said microwave generator to the object along a third direction crossing said first direction.

8. The microwave processing apparatus according to claim 7, wherein
said microwave generator includes first and second microwave generators,
said first and second radiators radiate to the object the microwave generated by said first microwave generator, and
said third radiator radiates to the object the microwave generated by said second microwave generator.

9. The microwave processing apparatus according to claim 1, wherein
said first radiator radiates the microwave along a first direction, and said second radiator radiates the microwave along a second direction opposite to said first direction, further comprising:
a third radiator that radiates the microwave generated by said microwave generator to the object along a third direction crossing said first direction, and
a fourth radiator that radiates the microwave generated by said microwave generator to the object along a fourth direction opposite to said third direction,
wherein said third and fourth radiators are opposite each other.

10. The microwave processing apparatus according to claim 9, further comprising a second phase variator that changes a phase difference between the microwaves respectively radiated from said third and fourth radiators.

11. The microwave processing apparatus according to claim 10, wherein
said microwave generator includes first and second microwave generators,
said first and second radiators radiate to the object the microwave generated by said first microwave generator, and
said third and fourth radiators radiate to the object the microwave generated by said second microwave generator.

12. The microwave processing apparatus according to claim 1, wherein the object is processed by heating processing, further comprising:
a heating chamber that accommodates the object for heating.
